(19) United States
(12) Patent Application Publication
(10) Pub. No.: US 2015/0190891 A1
(43) Pub. Date: Jul. 9, 2015

(54) Repair of Casting Defects

(71) Applicant: United Technologies Corporation, Hartford, CT (US)

(72) Inventors: Wangen Lin, South Glastonbury, CT (US); Robert P. Schaefer, Vernon Rockville, CT (US); Chris Vargas, West Hartford, CT (US)

(21) Appl. No.: 14/418,675

(22) PCT Filed: Jul. 19, 2013
(86) PCT No.: PCT/US2013/051279

§ 371 Date: Jan. 30, 2015

Related U.S. Application Data
(60) Provisional application No. 61/707,233, filed on Sep. 28, 2012.

(51) Int. Cl. B23P 6/04; B23K 1/20; B23K 31/02; B23K 1/00

(52) U.S. Cl. CPC B23P 6/04; B23K 1/0018; B23K 1/20; B23K 1/206; B23K 31/02

(57) ABSTRACT

A method of repairing defects in a casting formed from non-weldable or difficult-to-weld alloys is disclosed. The method includes removing the defect from the casting thereby forming a cavity in the casting, placing a filler material in the cavity and fusion welding the filler material in the cavity. The fusion welding produces surface cracks on the casting and sub-surface cracks in the casting. The method then includes brazing at least some of the surface cracks on the casting and processing the casting with a hot isostatic pressure (HIP) process to close at least some of the sub-surface cracks in the casting.

### CROSS-REFERENCE TO RELATED APPLICATIONS

This application is 35 U.S.C. §371 U.S. National Stage filing of International Patent Application No. PCT/US13/51279 filed on Jul. 19, 2013, claiming priority to U.S. provisional Patent Application No. 61/707,233 filed on Sep. 28, 2012.

### TECHNICAL FIELD

This disclosure relates to the repair of parts cast from non-weldable alloys.

### BACKGROUND

Casting is a manufacturing process by which a liquid material is usually poured into a mold, which contains a hollow cavity of the desired shape, and then the liquid material is allowed to solidify. The solidified part, which is also known as a casting, is ejected or broken out of the mold to complete the process. Casting is most often used for making complex shapes that would be otherwise difficult or uneconomical to make by other methods. During a casting process, some casting defects can be difficult to avoid. Further, it may be cost prohibitive to produce a defect-free casting of a part with complex features or geometries.

Welding is a fabrication or sculptural process that joins materials, such metals by causing coalescence. Welding is performed by melting the work pieces and adding a filler material to form a pool of molten material (the weld pool) that cools to become a strong joint. Pressure with or without heat can be used to produce the weld. In contrast, soldering and brazing involve melting lower-melting-point materials between the work pieces to form a bond between them, without melting the work pieces.

Welding may generally be used to repair casting defects for some alloys, but unfortunately, some properties that make an alloy attractive for casting causes the alloy to be unweldable or very difficult to weld. Alloys may be categorized as not weldable due to a propensity to form cracks in the weld deposit or in the heat affected zone (HAZ) either during welding or during post-weld heat treatments. Such alloys can only be weld repaired under extreme conditions, for example at temperatures in excess of 1600° F. (871° C.). Further, the geometry of the part may be too thin for a weld repair. Fusion welding is a generic term for a welding process that relies upon melting to join materials of similar compositions and melting points. Due to the high-temperature phase transitions inherent in fusion welding, a heat-affected zone (HAZ) is created in the material.

Brazing is a metal joining process whereby a filler metal is heated above melting point and distributed between two or more close-fitting parts by capillary action. The filler metal is brought slightly above its melting (liquidus) temperature while protected by a suitable atmosphere, usually a flux. The brazing material then flows over the base metal (known as wetting) and is then cooled to join the work pieces together. It is similar to soldering, except the temperatures used to melt the filler metal are higher than a typical welding process.

Hot isostatic pressing (HIP) is a manufacturing process used to reduce the porosity of metals. HIP subjects a component to both an elevated temperature and an isostatic gas pressure in a high pressure containment vessel. The pressurizing gas most widely used is argon, an inert gas, so that the metal and inert gas do not chemically react. The chamber is heated, causing the pressure inside the vessel to increase. Many systems use gas pumps to achieve the necessary pressure level. Pressure is applied to the material from all directions (hence the term “isostatic”). When castings are treated with HIP, the simultaneous application of heat and pressure eliminates internal voids and micro-porosity through a combination of plastic deformation, creep, and diffusion bonding. HIP also improves fatigue resistance of component.

### SUMMARY

In one aspect, a method of repairing a defect in a casting that consists essentially of a non-weldable alloy is disclosed. The disclosed method may include removing the defect from the casting thereby forming a cavity. The method may then include placing a filler material in the cavity and fusion welding the filler material in the cavity. The fusion welding may produce surface cracks on the casting and sub-surface cracks in the casting. The method may then include brazing at least some of the surface cracks on the casting. The method may also include processing the casting with a hot isostatic pressure (HIP) process to close at least some of the sub-surface cracks in the casting.

In another aspect, a method is disclosed for repairing a defect in a casting that consists essentially of a non-weldable alloy or a difficult to weld alloy. The method may include forming a cavity in the casting by removing the defect. The method may also include placing filler material in the cavity wherein the filler material has a strength that is less than or about equal to the strength of the alloy. The method may further include fusion welding the filler material in the cavity. The fusion welding may produce surface cracks on the casting and sub-surface cracks in the casting near the cavity. The method may then include brazing at least some of the surface cracks on the casting and the method may further include processing the casting with a hot isostatic pressure (HIP) process to close at least some of the sub-surface cracks in the casting.

In yet another aspect, a method of casting at least part of a mid-turbine frame is disclosed. The method may include providing a mold and filling the mold with a non-weldable alloy or an alloy that is difficult to weld thereby forming a casting. The method may then include ejecting the casting from the mold wherein the casting has at least one defect. The method may then include forming a cavity in the casting by removing the defect. The method may then include placing filler material in the cavity wherein the filler material has a strength that is less than or about equal to a strength of the alloy. The method may also include fusion welding the filler material in the cavity wherein the fusion welding may produce surface cracks on the casting and sub-surface cracks in the casting near the cavity. The method may also include simultaneously brazing at least some of the surface cracks on the casting and HIP processing to close at least some of the sub-surface cracks in the casting.

### DESCRIPTION

A gas turbine engine has a mid-turbine frame (MTF) disposed between the high and low pressure turbines. MTFs support bearing systems of the turbines and also provide a connection between inner case and the outer case of the engine. Material is used for fabricating MTFs must be able to withstand elevated temperatures and substantial stresses. Certain nickel based alloys, such as Mar-M-247 or Rene 108 maintain excellent strength properties at elevated temperatures and therefore are attracted alloys for use in fabricating MTFs. However, these alloys generally must be cast due to the technical difficulties associated with processing these alloys into other wrought forms, such as plates and bars. However, it is the nature of the casting process that some casting defects can be difficult or impossible to avoid. Essentially, it may be cost prohibitive to produce a defect-free casting of a part with a complex geometry.

To repair casting defects, various welding techniques are employed. However, the nickel base alloys that provide excellent material properties at elevated temperatures, may also be either difficult to weld or generally unweldable. In fact, may nickel base alloys are categorized as being not weldable due to their propensity to form cracks in the weld deposit in the heat effective zone (HAZ), either during welding or during post-welding heat treatments. As a result, many nickel based alloys can only be weld repaired under extreme conditions, such as in excess of 1600° F. (871° C.).

Methods are disclosed herein that provide solutions to these problems. Specifically, methods of repairing castings made of unweldable or difficult to weld nickel based alloys are disclosed that may include as few as four primary parts. Further, after the part is cast, the defect is removed from the casting, either mechanically or manually, which results in the formation of a cavity in the casting. Then, the casting may be filled with a filler material that either matches the strength of the nickel based alloy (“matching”) or that has a strength that is less than that of the nickel based alloy (“under matched”). The filler material may be in the form of a powder, a wire or a rod. A fusion weld process is used to fill the cavity with the filler material. Fusion weld processes may impart surface cracks on the outside of the casting as well as interior cracks inside the casting, near the cavity. To fix these cracks, or new defects, a brazing process is carried out to seal the surface cracks produced during the fusion weld process. Then, or simultaneously, a hot isostatic pressure (HIP) process may be used to close the sub-surface cracks produced during the fusion weld process.

The cracks produced during the fusion weld process are typically small and narrow. Further, the crack surfaces may be clean because they are formed under an inert gas environment or the cracks may be disposed internally such as in the heat affected zone (HAZ). As a result, the cracks can be sealed and closed using the combination of brazing and HIP processing.

Optionally, a cleaning method may be carried out prior to the brazing. One suitable cleaning material is hydrogen fluoride. This step may not be necessary and is therefore considered to be optional.

The disclosed methods may be used to repair virtually all castings with complex geometries. Although the brazing and HIP processing may be carried out separately, the total cost may be reduced if the brazing and HIP treatment are combined with a post repair heat treatment process.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method of repairing a defect in a casting consisting essentially of a non-weldable alloy, the method comprising:
removing the defect from the casting thereby forming a cavity;
placing filler material in the cavity and fusion welding the filler material in the cavity, the fusion welding producing surface cracks on the casting and sub-surface cracks in the casting;
brazing at least some of the surface cracks on the casting;
processing the casting with a hot isostatic pressure (HIP) process to close at least some of the sub-surface cracks in the casting.

2. The method of claim 1 wherein the filler material is a matching material with respect to the non-weldable alloy of the casting.

3. The method of claim 1 wherein the filler material is an under matching filler material with respect to the non-weldable alloy of the casting.

4. The method of claim 1 further including cleaning the casting before brazing.

5. The method of claim 4 wherein the cleaning includes exposing the casting to HF gas.

6. The method of claim 5 wherein the exposing of the casting to HF takes place in a sealed chamber.

7. The method of claim 1 wherein the removing of the defect is performed manually.

8. The method of claim 1 wherein the removing of the defect is performed mechanically.

9. The method of claim 1 wherein the casting has a complex geometry.

10. The method of claim 1 further including a post-repair heat treatment process.

11. The method of claim 1 wherein the brazing and the HIP process are combined with a post-repair heat treatment process.

12. The method of claim 1 wherein the casting forms at least part of a mid-turbine frame (MTF).

13. A method of repairing a defect in a casting consisting essentially of a non-weldable alloy or a difficult to weld alloy, the method comprising:
forming a cavity in the casting by removing the defect;
placing filler material in the cavity, the filler material having a strength that is less than or about equal to a strength of the alloy;
fusion welding the filler material in the cavity, the fusion welding producing surface cracks on the casting and sub-surface cracks in the casting near the cavity;
brazing at least some of the surface cracks on the casting;
processing the casting with a hot isostatic pressure (HIP) process to close at least some of the sub-surface cracks in the casting.

14. The method of claim 13 further including cleaning the casting before brazing.

15. The method of claim 14 wherein the cleaning includes exposing the casting to HF gas.

16. The method of claim 15 wherein the exposing of the casting to HF takes place in a sealed chamber.

17. The method of claim 13 wherein the removing of the defect is performed manually.

18. The method of claim 13 wherein the removing of the defect is performed mechanically.

19. The method of claim 13 wherein the brazing and the HIP process are combined with a post-repair heat treatment process.

20. A method of casting at least part of a mid-turbine frame, the method comprising:
providing a mold;
filling the mold with a non-weldable alloy or a difficult to weld alloy to form a casting;
ejecting the casting from the mold, the casting having at least one defect;
forming a cavity in the casting by removing the defect;
placing filler material in the cavity, the filler material having a strength that is less than or about equal to a strength of the alloy;
fusion welding the filler material in the cavity, the fusion welding producing surface cracks on the casting and sub-surface cracks in the casting near the cavity; and
simultaneously brazing at least some of the surface cracks on the casting and processing the casting with a hot isostatic pressure (HIP) process to close at least some of the sub-surface cracks in the casting.
